(19) United States
(12) Patent Application Publication
(10) Pub. No.: US 2010/0098874 A1
(43) Pub. Date: Apr. 22, 2010

(54) Method and Apparatus for Reacting Thin Films on Low-Temperature Substrates at High Speeds

(76) Inventor: Kurt A. Schroder, Coupland, TX (US)

Correspondence Address: DILLON & YUDELL LLP, 8911 NORTH CAPITAL OF TEXAS HWY, SUITE 2110, AUSTIN, TX, 78759, US

(21) Appl. No.: 12/581,606

(22) Filed: Oct. 19, 2009

Related U.S. Application Data
(60) Provisional application No. 61/196,531, filed on Oct. 17, 2008.

(51) Int. Cl. B05D 3/06

(52) U.S. Cl. 427/532; 118/642

(57) ABSTRACT

A method for reacting thin films on a low-temperature substrate within a reactive atmosphere is disclosed. The thin film contains a reducible metal oxide, and the reactive atmosphere contains a reducing gas such as hydrogen or methane. The low-temperature substrate can be polymer, plastic or paper. Multiple light pulses from a high-intensity strobe system are used to reduce the metal oxide to metal and to sinter the metal if applicable.

### PRIORITY CLAIM

The present application claims priority under 35 U.S.C. §119(e)(1) to provisional application No. 61/196,531 filed on Oct. 17, 2008, the contents of which are incorporated herein by reference.

### BACKGROUND OF THE INVENTION

1. Technical Field

The present invention relates to curing methods in general, and, in particular, to a method and apparatus for reacting thin films on low-temperature substrates at high speeds.

2. Description of Related Art

One approach to making electrical conductors on circuits is to print metal-containing ink onto a substrate, and to then heat the substrate for sintering the particles in the metal-containing ink to form a conducting path. Generally, most metals suitable for electrical conduction need to be heated to a very high temperature, which is often in the range of a couple hundred degrees centigrade of their melting point. For example, silver is a good metal for making conductive traces because it can be heated in air and that its oxides, which are comparatively low in conductivity, decompose at relatively low temperatures. In addition, the fact that silver being the most electrically conductive metal often outweighs its high cost when comes to choosing a metal for making conductive traces.

Another metal that is being constantly pursued in the manufacturing of conductive traces is copper because of its low cost. Copper has about 90% of the conductivity of silver but is usually 50 to 100 times cheaper than silver on a mass basis. However, silver inks still dominate the printed electronics market because the additional cost of making and processing the copper inks to avoid oxidation is generally higher than the difference in cost of the bulk materials. Basically, when copper particles are heated in air, they oxidize before they sinter, which results in a non-conductor.

Consequently, it would be desirable to provide an improved method for making conductive traces using relatively low cost metals such as copper.

### SUMMARY OF THE INVENTION

In accordance with a preferred embodiment of the present invention, a gaseous atmosphere is initially provided. A layer of thin film located on top of a low-temperature substrate is then transported through the gaseous atmosphere. When the layer of thin film is being moved within the gaseous atmosphere, the layer of thin film is exposed to multiple pulsed electromagnetic emissions to allow the layer of thin film to be chemically reacted with the gaseous atmosphere.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of a curing apparatus, in accordance with a preferred embodiment of the present invention; and

FIG. 2 is a high-level logic flow diagram of a method for reacting thin films on a low-temperature substrate, in accordance with a preferred embodiment of the present invention.

### DETAILED DESCRIPTION OF A PREFERRED EMBODIMENT

It is well known that some metal oxides can be reduced by hydrogen or hydrocarbons at an elevated temperature if they have a positive reduction potential. Examples include oxides of copper, gold, platinum, and palladium. Copper can be made by mixing copper oxide bearing ore with charcoal via a heating process. When oxidized copper particles or even pure copper oxide is heated in a reducing atmosphere, the particles can sinter to form a conductor.

When making thin film conductors by printing copper particles, a very conductive trace can be formed if the particles are heated to their sintering temperature in an inert or reducing atmosphere. Since the melting point of copper is nearly 1,085° C., the temperature required for sintering demands that only high-temperature substrates, such as glass or ceramic, can be utilized. This relatively high temperature requirement on substrates prevents the usage of inexpensive substrates such as paper or plastic.

Alternatively, if copper oxide is placed on a low-temperature substrate, the copper oxide can be heated to near the substrate's decomposition temperature and the low-temperature substrate can be placed in a reducing atmosphere. However, the low temperature dramatically increases the amount of time needed to minutes or even hours depending on the substrate thickness. Still, at these low temperatures, sintering is very limited. The substrate temperature and gas atmosphere requirements can be overcome if an intense, short pulse of light is utilized to cure the substrate. Unfortunately, these approaches do nothing to address the residual oxide in the copper film. Reducible metal oxide can be placed between two electrical contacts in a hydrogen atmosphere, and electrical current can be repetitively pulsed through the oxide to heat the oxide and to reduce the oxide. However, this technique requires electrical contacts and its throughput is relatively limited. Thus, there is a need to reduce metal oxide on low-temperature substrates with a high throughput.

For the present invention, curing is defined as thermal processing, which includes reacting a thin film with a gaseous atmosphere. Thin film is defined as a coating less than 100 microns thick. A low-temperature substrate can be made of paper, plastic or polymer. An electromagnetic emission may include electromagnetic radiation comprising gamma rays, x-rays, ultraviolet, visible light, infrared, millimeter waves, microwaves, or radiowaves. Electromagnetic emission sources include lasers, induction heaters, microwave generators, flashlamps, light emitting diodes, etc.

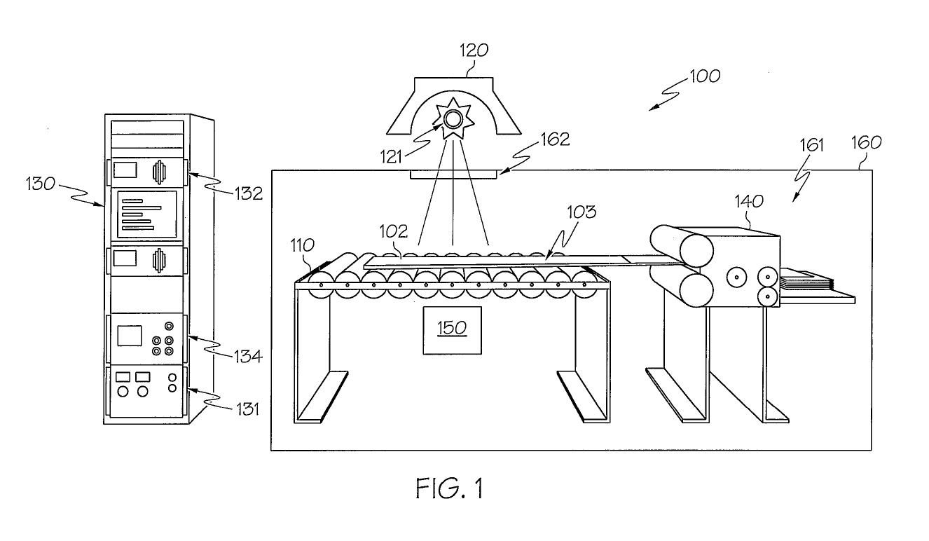

Referring now to the drawings and in particular to FIG. 1, there is depicted a diagram of a curing apparatus, in accordance with a preferred embodiment of the present invention. As shown, a curing apparatus 100 includes a conveyor belt system 110, a strobe head 120, a relay rack 130 and a reel-to-reel feeding system 140. Curing apparatus 100 is capable of curing a thin film 102 mounted on a low-temperature substrate 103 situated on a web being moved across a conveyor belt at a relative high speed. Conveyer belt system 110 can operate at speeds from 0 to 1,000 ft/min, for example, to move substrate 103. Curing apparatus 100 can accommodate a web of any width in 6-inch increments. Thin film 102 can be added on substrate 103 by one or combinations of existing technologies such as screen printing, inkjet printing, gravure, laser printing, xerography, pad printing, painting, dip-pen, syringe, airbrush, flexographic, chemical vapor deposition (CVD), evaporation, sputtering, etc.

Strobe head 120, which is preferably water cooled, includes a high-intensity pulsed xenon flash lamp 121 for curing thin film 102 located on substrate 103. Pulsed xenon flash lamp 121 can provide pulses for different intensity, pulse length, and pulse repetition frequency. For example, pulsed xenon flash lamp 121 can provide 10 microseconds to 50 milliseconds pulses with a 3″ by 6″ wide beam at a pulse repetition rate of up to 1 kHz. The spectral content of the emissions from the pulsed xenon flash lamp 121 ranges from 200 nm to 2,500 nm. The spectrum can be adjusted by replacing the quartz lamp with a cerium doped quartz lamp to remove most of the emission below 350 nm. The quartz lamp can also be replaced with a sapphire lamp to extend the emission from approximately 140 nm to approximately 4,500 nm. Filters may also be added to remove other portions of the spectrum. Flash lamp 121 can also be a water wall flash lamp that is sometimes referred to a Directed Plasma Arc (DPA) lamp.

Relay rack 130 includes an adjustable power supply 131, a conveyor control module 132, and a strobe control module 134. Adjustable power supply 131 can produce pulses with an energy of up to 4 kilojoules per pulse. Adjustable power supply 131 is connected to pulsed xenon flash lamp 121, and the intensity of the emission from pulsed xenon flash lamp 121 can be varied by controlling the amount of current passing through pulsed xenon flash lamp 121.

Adjustable power supply 131 controls the emission intensity of pulsed xenon flash lamp 121. The power, pulse duration and pulse repetition frequency of the emission from pulsed xenon flash lamp 121 are electronically adjusted and synchronized to the web speed to allow optimum curing of thin film 102 without damaging substrate 103, depending on the optical, thermal and geometric properties of thin film 102 and substrate 103.

During curing operation, substrate 103 as well as thin film 102 are being moved onto conveyor belt system 110. Conveyor belt system 110 moves thin film 102 under strobe head 120 where thin film 102 is cured by rapid pulses from pulsed xenon flash lamp 121. The power, duration and repetition rate of the emissions from pulsed xenon flash lamp 121 are controlled by strobe control module 134, and the speed at which substrate 103 is being moved past strobe head 120 is determined by conveyor control module 132.

A sensor 150, which can be a mechanical, electrical, or optical sensor, is utilized to sense the speed of conveyor belt system 110. For example, the conveyor belt speed of conveyor belt system 110 can be sensed by detecting a signal from a shaft encoder connected to a wheel that made contact with the moving conveyor belt. In turn, the pulse repetition rate can be synchronized with the conveyor belt speed of conveyor belt system 110 accordingly. The synchronization of the strobe pulse rate f is given by:

$$f = \frac{0.2 * S * O}{W}$$

where
f=strobe pulse rate [Hz]
S=web speed [ft/min]
O=overlap factor
W=curing head width [in]
   Overlap factor O is the average number of strobe pulses that are received by a substrate. For example, with a web speed of 200 ft/min, and overlap factor of 5, and a curing head width of 2.75 inches, the pulse rate of a strobe is 72.7 Hz.

An enclosure 160 surrounds substrate 103 and contains a reducing atmosphere 161. A transparent window 162 passes light from flash lamp 121. When flash lamp 121 is pulsed, film 102 is momentarily heated and chemically reacts with atmosphere 161. When a rapid pulse train is combined with moving substrate 103, a uniform cure can be attained over an arbitrarily large area as each section of thin film 102 is exposed to multiple pulses, which approximates a continuous curing system such as an oven.

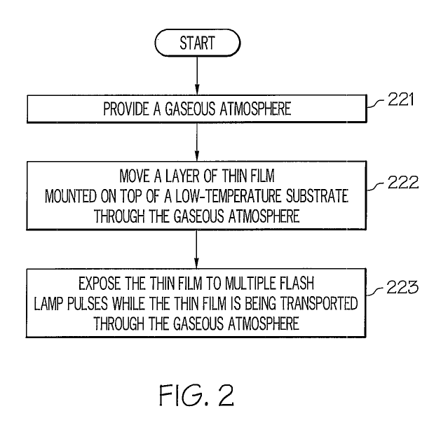

With reference now to FIG. 2, there is depicted a high-level logic flow diagram of a method for reacting thin films on a low-temperature substrate, in accordance with a preferred embodiment of the present invention. Initially, a gaseous atmosphere containing a reducing gas, such as reducing atmosphere 161 from FIG. 1, is provided, as shown in block 221. Preferably, the gaseous atmosphere contains hydrogen or a hydrocarbon such as methane, propane, etc.

Next, a layer of thin film located on top of a low-temperature substrate is move through the gaseous atmosphere, as depicted in block 222. The thin film preferably contains a reducible metal oxide such as copper oxide (CuO), gold oxide (Ag₂O), platinum oxide (PtO) and palladium oxide (PdO), etc. For reasons of economy, copper is desirable as a conductor for printed electronics. A printed copper film often contains copper oxide, which is a barrier to electronic conduction. The low-temperature substrate can be made of polymer or paper.

Each segment (i.e., the curing head width) of the layer of thin film is then exposed to at least one pulse from a flash lamp, such as flash lamp 121 from FIG. 1, while the layer of thin film is being transported through the gaseous atmosphere, as shown in block 223, to allow the layer of thin film to be chemically reacted with the gaseous atmosphere. Basically, the pulses from the strobe system reduce the thin film of metal oxide, such as copper oxide, on the low-temperature substrate to form a conductive metal film, such as copper film, in less than one second without damaging the low-temperature substrate.

When reducing a metal oxide to a metal in a hydrogen environment, the speed at which the reaction progresses is diffusion limited. The diffusion rate is related to the temperature of the curing system. When an oven is utilized, the temperature is limited by the decomposition temperature of the low-temperature substrate. The pulsed light heats the metal oxide to a very high temperature without decomposing the low-temperature substrate. This dramatically reduces the time to reduce the metal oxide.

As has been described, the present invention provides a method and apparatus for reacting thin films on low-temperature substrates. One advantage of the present invention is that a metal thin film can be obtained even when pure metal oxide is initially deposited. One of the motivations to deposit metal oxide particles is that they are more readily available than their metal counterparts, particularly when they are in a nanoparticle form. It is particularly difficult to make very fine (tens of nm) metal particles while maintaining their purity. The very fine metal particles are usually coated with either an oxide and/or a capping group. In addition, metal oxide particles can be more easily dispersed, and can be more easily printed on a variety of substrates.

Another advantage of the present invention is that it requires no registration. If the thin film is a printed pattern, only that pattern is reacted while the unprinted portions of the low-temperature substrate that generally are less absorptive of the light pulses are left cool.

While the reduction of a metal oxide is shown to be in a reducing atmosphere to form a metal film, other film/reactive gas combinations are also possible. Other examples include:
(1) Reduction with H₂ (or creation of hydrides for H₂ storage materials).
(2) Oxidation with O₂ (for dielectrics).
(3) Carburization with carbonaceous gases for the formation of carbides. The partial pressure of O₂ within the carbonaceous gas stream for the formation of oxycarbides.
(4) Nitridation with ammonia or amines for the formation of nitrides. The partial pressure of O₂ within the ammonia or amine gas stream for the formation of oxynitrides.
(5) Formation of chalcogenides from various precursor gases. Chalcogenides are sulfides (S²⁻), selenides (Se²⁻), and tellurides (Te²⁻). This covers a large family of semiconductors (II-VI semiconductors), e.g., ZnS, ZnSe, CdS, CdSe, CdTe, etc.
(6) Formation of pnictides from various precursor gases. Pnictides are phosphides (P³⁻), arsenides (As³⁻), and antimonides (Sb³⁻). This also covers the synthesis of a large family of semiconductors (III-V class semiconductors), e.g., GaP, GaAs, InP, InAs, InSb, etc.

While the invention has been particularly shown and described with reference to a preferred embodiment, it will be understood by those skilled in the art that various changes in form and detail may be made therein without departing from the spirit and scope of the invention.

What is claimed is:

1. A method for reacting a thin film on a low-temperature substrate, said method comprising:
providing a gaseous atmosphere;
moving a layer of thin film mounted on a low-temperature substrate through said gaseous atmosphere; and
exposing said layer of thin film to a pulsed electromagnetic emission while said layer of thin film is being moved in relation to a source of said pulsed electromagnetic emissions within said gaseous atmosphere to allow said layer of thin film to be chemically reacted with said gaseous atmosphere.

2. The method of claim 1, wherein said gaseous atmosphere contains hydrogen.

3. The method of claim 1, wherein said gaseous atmosphere contains hydrocarbon gas.

4. The method of claim 1, wherein said gaseous atmosphere contains more than one gaseous species.

5. The method of claim 1, wherein said thin film is a metal compound containing a metal having a positive reduction potential.

6. The method of claim 5, wherein said metal compound is copper oxide.

7. The method of claim 5, wherein said metal compound is platinum oxide.

8. The method of claim 5, wherein said metal compound is palladium oxide.

9. The method of claim 1, wherein said thin film is a metal.

10. The method of claim 1, wherein said low-temperature substrate is made of plastic.

11. The method of claim 1, wherein said low-temperature substrate is made of paper.

12. The method of claim 1, wherein said low-temperature substrate is made of polymer.

13. A curing apparatus comprising:
an enclosure for providing a gaseous atmosphere;
a strobe head having a flash lamp for providing a pulsed electromagnetic emission to a layer of thin film mounted on a low-temperature substrate to allow said layer of thin film to be chemically reacted with said gaseous atmosphere; and
a conveyor system for moving said layer of thin film within said gaseous atmosphere in relation to said strobe head; and
a strobe control module for controlling power, duration, repetition rate and the number of said pulse electromagnetic emission generated by said flash lamp.

14. The curing apparatus of claim 13, wherein said flash lamp is a xenon flash lamp.

15. The curing apparatus of claim 13, wherein said low-temperature substrate is moved at a speed that is synchronized with said repetition rate of said pulsed electromagnetic emission.

16. The curing apparatus of claim 13, wherein said low-temperature substrate is conveyed by a reel-to-reel system.

17. The curing apparatus of claim 13, wherein said gaseous atmosphere contains hydrogen.

18. The curing apparatus of claim 13, wherein said gaseous atmosphere contains hydrocarbon gas.

19. The curing apparatus of claim 13, wherein said thin film is a metal compound containing a metal having a positive reduction potential.

20. The curing apparatus of claim 13, wherein said thin film is a metal.
